(19) United States
(12) Patent Application Publication
(10) Pub. No.: US 2018/0001949 A1
(43) Pub. Date: Jan. 4, 2018

(54) Device for supporting bicycle pannier

(71) Applicant: Benjamin Nicholas Varvil, San Francisco, CA (US)

(72) Inventor: Benjamin Nicholas Varvil, San Francisco, CA (US)

(21) Appl. No.: 15/426,425

(22) Filed: Feb. 7, 2017

Related U.S. Application Data
(60) Provisional application No. 62/356,425, filed on Jun. 29, 2016.

(51) Int. Cl. B62J 7/00; B62J 7/04; B62J 7/08; B62J 9/00

(52) U.S. Cl. CPC B62J 7/00; B62J 9/001; B62J 7/04; B62J 7/08; B62J 9/00

(57) ABSTRACT

The present invention provides means of connecting a single or multiple bicycle panniers to a supporting surface. By providing a means of connecting to a support surface such as wall or office cubicle, embodiments of this invention increase accessibility to an otherwise stored pannier. Use of embodiments of this invention have the new and unexpected result of reducing damage to panniers caused by routine contact with surfaces such as the ground or floor. This reduction of damage results in longer weatherproof and high visibility characteristics of panniers. Some embodiments of this invention contain partial replications of a standard bicycle rack, thus providing a connection method equal in connection/disconnection ease as between the pannier and said bicycle rack. Some embodiments of this invention provide a barrier between the pannier and the supporting surface, preventing wear to the supporting surface from repeated connection and removal of the panniers.

### CROSS-REFERENCE TO RELATED APPLICATIONS

The present application claims priority from application No. 62/356,425 of filing date Jun. 29, 2016 from Benjamin Nicholas Varvil titled “Wall mounted Storage Device for Bicycle Pannier”

### FEDERALLY SPONSORED RESEARCH

not applicable

### SEQUENCE LISTING OR PROGRAM LISTING:

not applicable

### BACKGROUND ART

Bicycles are a major mode of transportation for both people and their things. Removable storage compartments for bicycles, also known as “panniers,” (Inventor, U.S. Pat. No. 9,440,696, B2) are commonplace. Bicycle pannier designs often incorporate characteristics such as being lightweight, weatherproof, highly reflective and easy secure to a bicycle rack (inventor, U.S. Pat. No. 9,428,234 B2). Pannier manufacturers oftentimes produce a product resembling a fabric bag coated in a brightly colored, rubberlike material that has clip mechanism enabling secure attachment to a cyclist's bicycle rack. Reflective devices are often added to pannier to increase visibility of the pannier as a means of protection for the user while in vehicular traffic.

A typical user experience for a bicycle pannier involves the user loading the pannier with contents, carrying the filled pannier to the bicycle and then connecting the pannier to the bicycle rack using the clip mechanisms. When at the bicycling destination, the cyclist disconnects the pannier from the bike, carries the pannier to a further location, then unloads the contents. It is important to note that the filling and emptying of the pannier occurs while the pannier is not hanging from the bicycle rack, but likely while the fabric-like pannier is resting on the ground or other horizontal surface.

While resting on a horizontal surface, the pannier's thin fabric like walls oftentimes compresses unevenly under the weight of the contents, causing the pannier to fall to one side. Spilled drinks, damaged pannier contents and user frustration are example results in this scenario. Furthermore, in order to access contents of the pannier when it is on the ground or floor, a user must bend over, use one hand to lift or otherwise hold the bag open, then use the remaining hand to access the pannier contents. A sore lower back and limiting the user to one searching hand are drawbacks in scenarios such as a user searching to find keys that have vibrated to the bottom of the pannier during a ride.

Panniers in the current art are not designed with shock absorption. Therefore, pannier contents experience impact shock each time the user places the pannier on a horizontal surface such as the ground or floor. Damaged laptops, cracked tablets and bruised fruit are example results from this drawback.

Panniers in the current art are not designed with wear resistance. Therefore, the coated fabric walls of the pannier wear each time the user places the pannier on the ground, floor or other support surface. Wear to the outside of a pannier including to the reflective devices reduces weather resistance and visibility. Shortening the lifespan of the pannier is the result of this wear.

(Inventor) (www.bullrack.com) provides wall mounted, locking storage devices for motorcycle side-cases. Motorcycle side-cases are very different from bicycle panniers. Motorcycle side-cases are typically in the price range of $500-$600 USD, are hard with hinged lids and are designed to lock securely to the motorcycle, staying there for the life of the motorcycle. Bicycle panniers are typically in the price range of $60-$120 USD and are designed to attached and detached every time the user rides the bicycle. The prior art by bullrack does not discuss or address lower cost bicycle panniers in any way. The prior art by bullrack addresses long term storage and does not in any way discuss daily use. Bullrack's prior art is for long term storage of a motorcycle side case in the event that the motorcycle owner has decided to remove them. The prior art does not discuss or address the idea of loading and unloading of contents from the motorcycle side-cases. Again, the focus of this prior art is on long term storage.

### SUMMARY OF VARIOUS EMBODIMENTS

The present embodiments of this invention enable a bicycle pannier user to unfasten a pannier's attachment mechanism from a bicycle rack and to attach said pannier to a support structure such as a wall, door, or office divider. By securely storing the pannier at, say, a waist-high location on a wall, accessing the inside-bottom of the pannier can be done without bending over. By storing the pannier on the wall, the outside-bottom of the bag is not in contact with the ground, reducing damage to and extending the lifespan of the pannier. Additionally, by hanging the pannier, the contents of the pannier are not exposed to impact shock of the user placing the pannier on the ground. Present embodiments also protect the wall from wear caused by repeated attachment and detachment of the pannier.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a computer aided perspective of one partially fabricated example wall mounted bicycle pannier storage device that has been stamped or otherwise cut out of sheet metal.

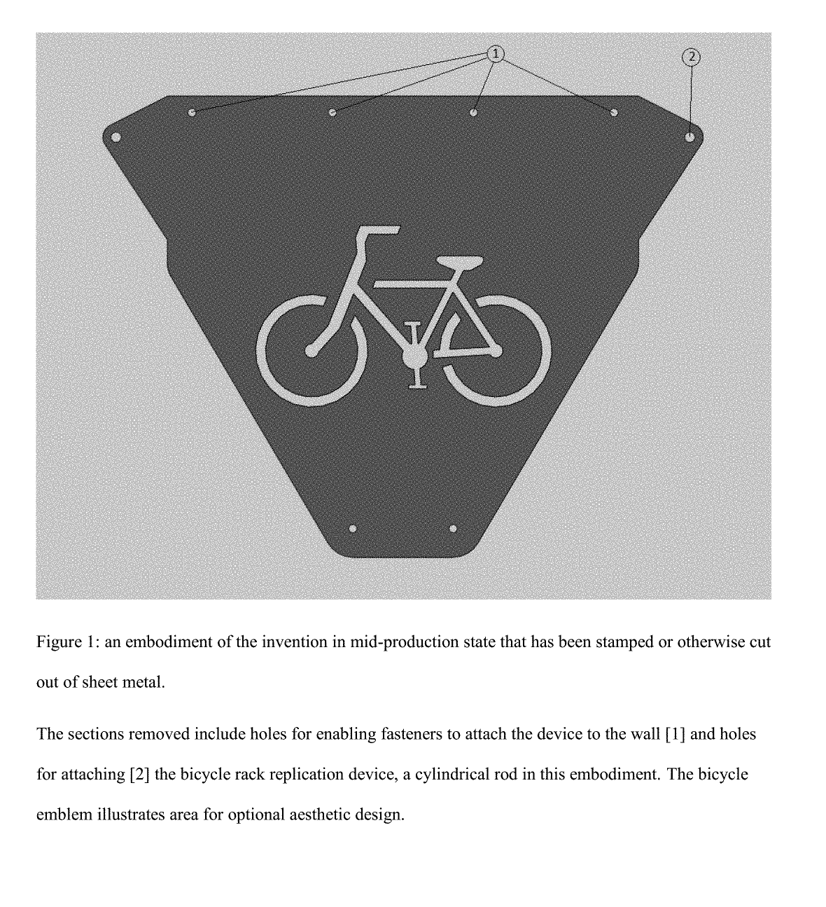

FIG. 2 depicts a computer aided perspective of one example wall mounted bicycle pannier storage device that has been bent at the sides and equipped with a metal rod mimicking the bicycle rack to which the pannier has been designed to attach.

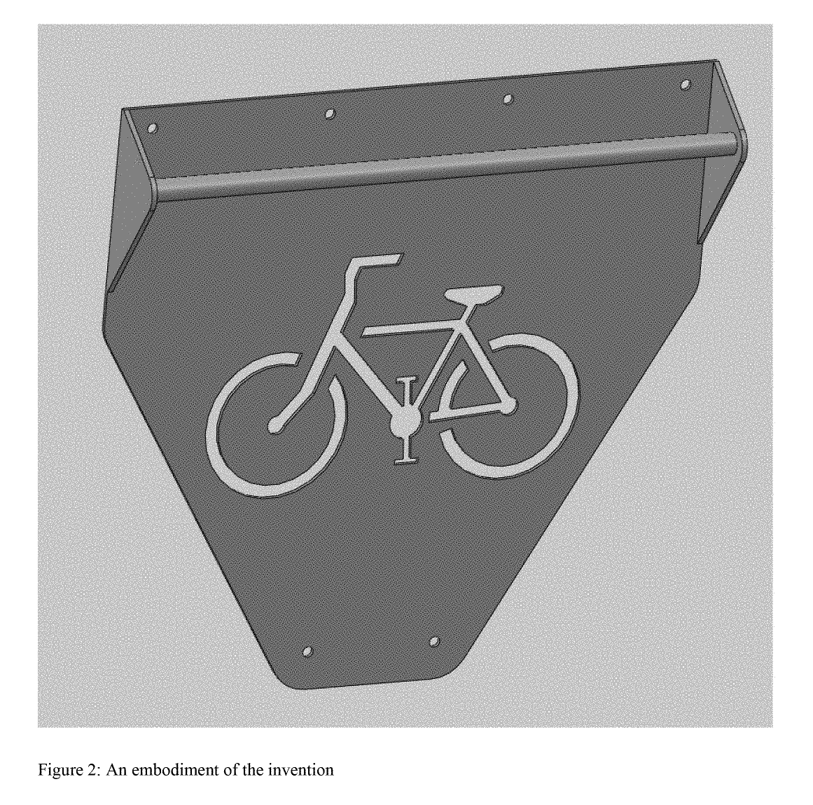

FIG. 3 depicts a computer aided perspective of one example wall mounted bicycle pannier storage device including example fastening hardware that could be used to attach the device to a wall, door or other support surface.

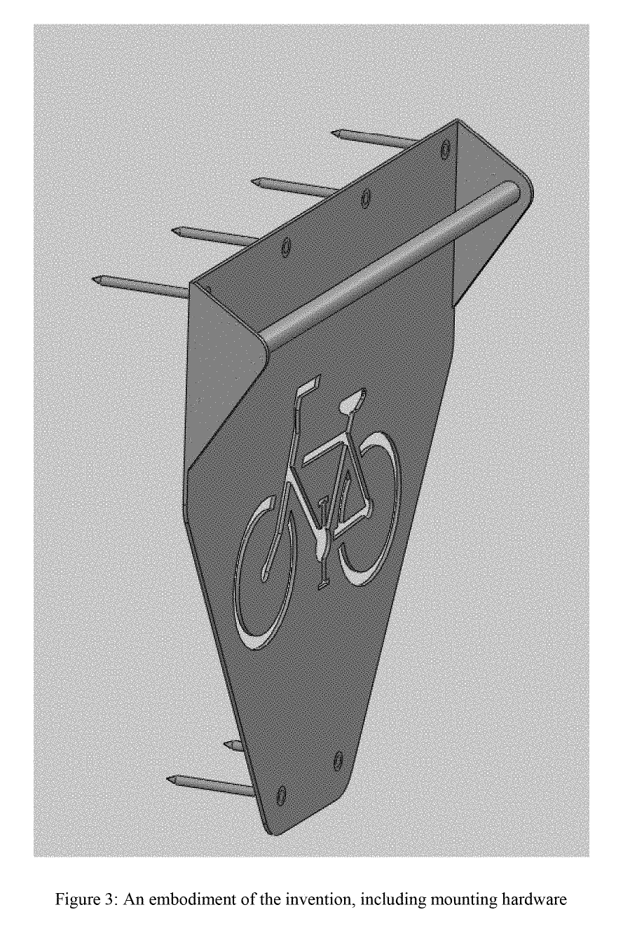

FIG. 4 depicts a common bicycle rack designed to interact with panniers.

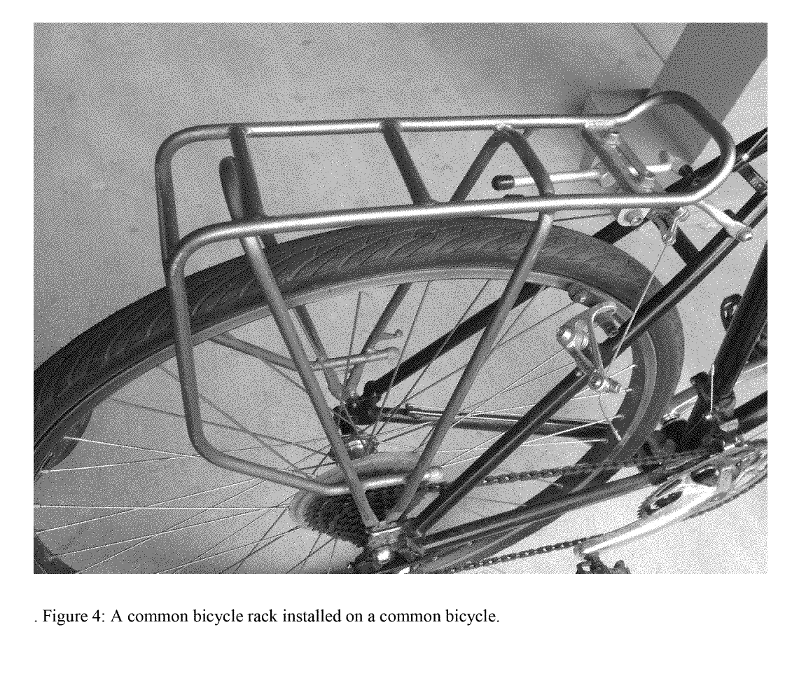

FIG. 5 depicts a common pannier being attached to a bicycle rack using clipping mechanisms.

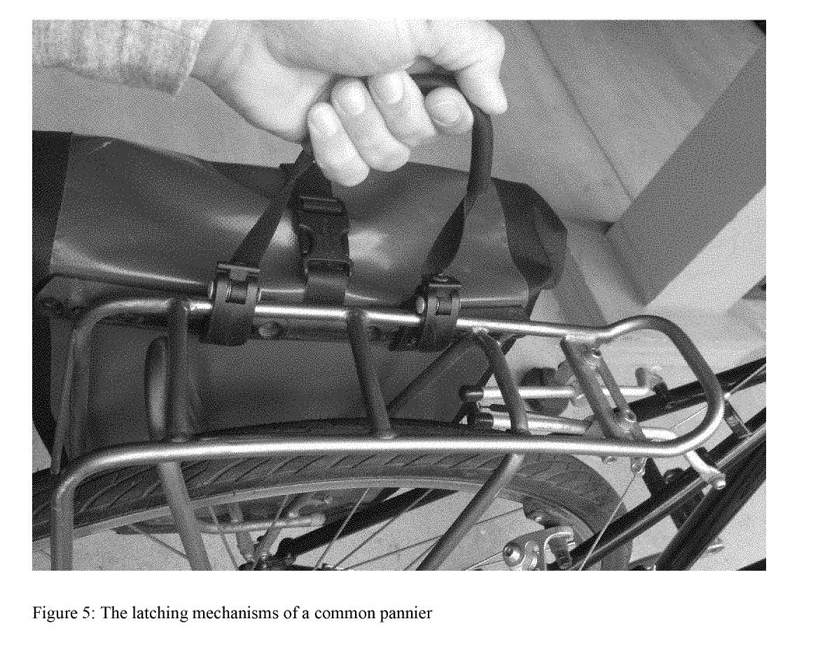

FIG. 6 depicts two example wall mounted bicycle pannier storage devices attached to a wall.

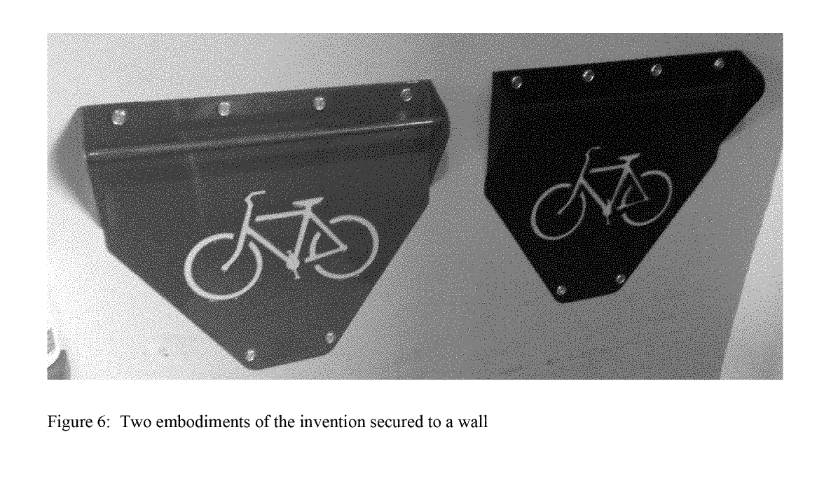

FIG. 7 depicts two embodiments of the invention attached to a wall, one supporting a bicycle pannier.

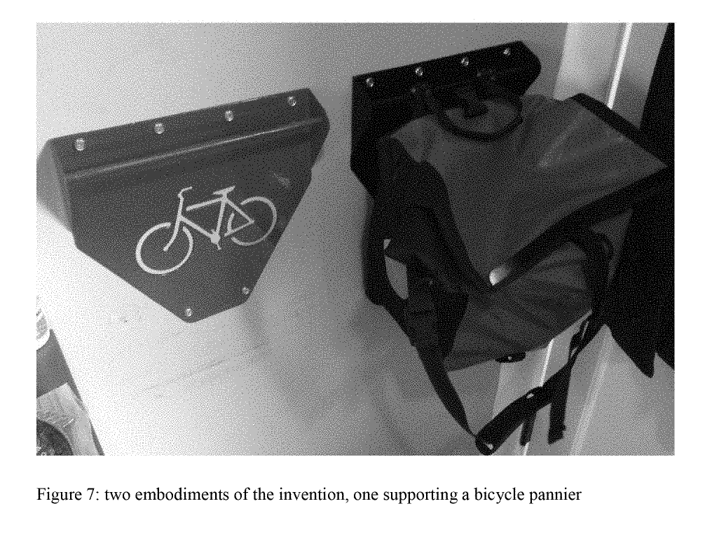

FIG. 8 Shows an embodiment of the invention including a clip mechanism at the top to hold the pannier open for easier access to the contents.

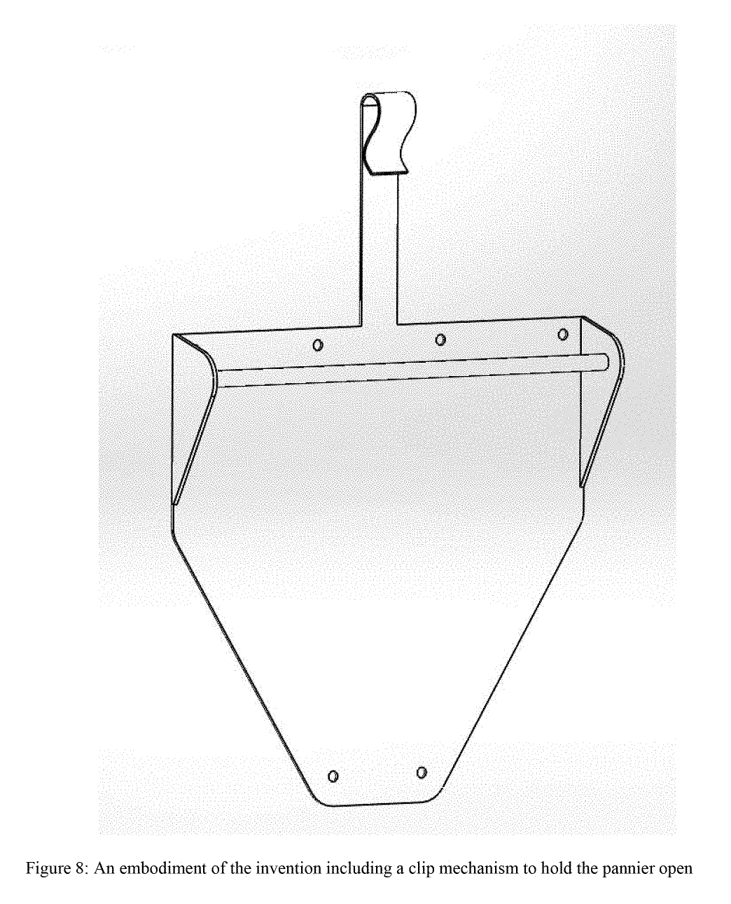

FIG. 9: Shows an embodiment of the invention with space and support for two bicycle pannier to be supported

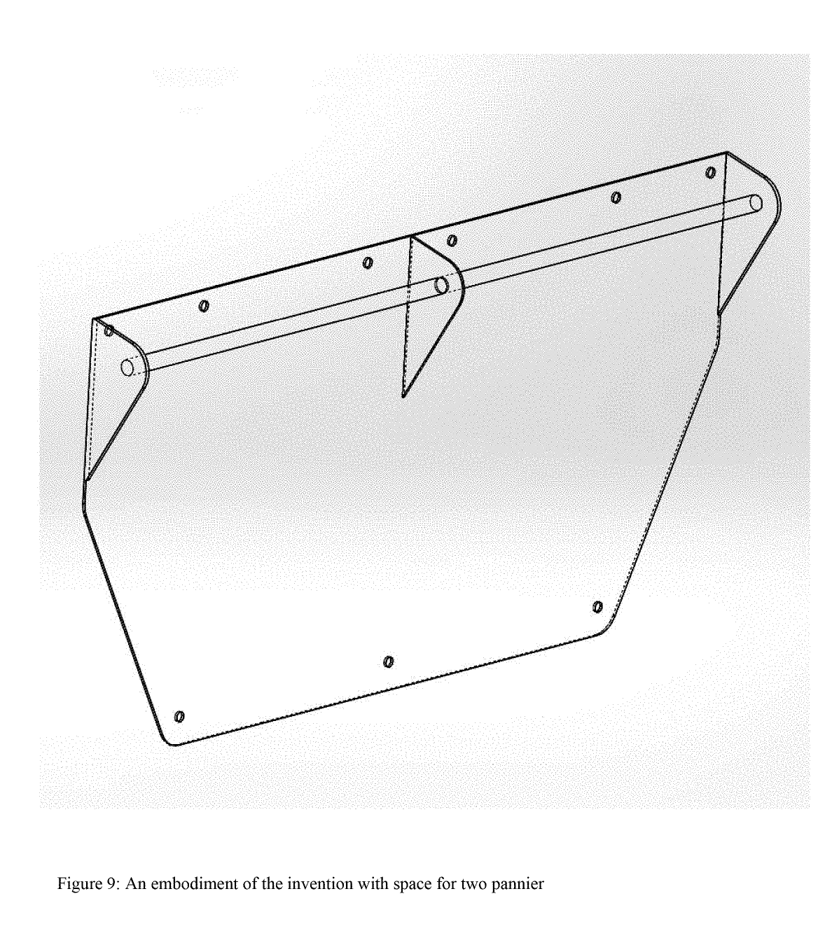

FIG. 10: An embodiment of the invention without the scuff guard below to protect the supporting surface from contact with the pannier bottom bracket.

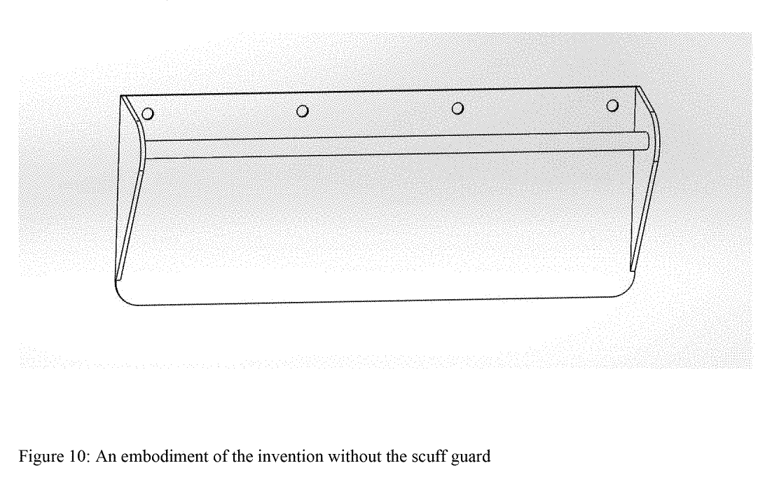

FIG. 11: An embodiment of the invention in an alternative rendering

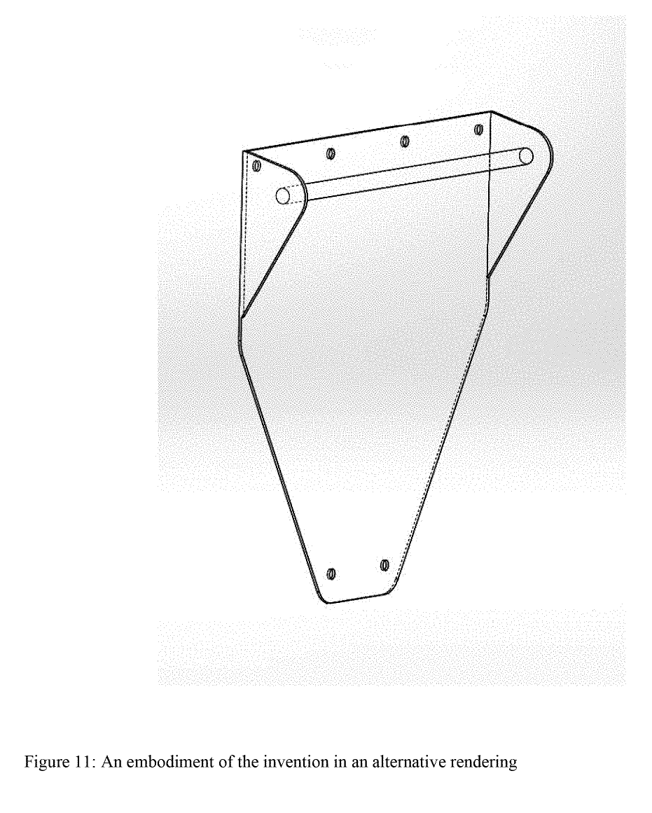

FIG. 12: An embodiment of the invention utilizing hooks to hang over the top of a support surface such as an office cubicle wall or a door.

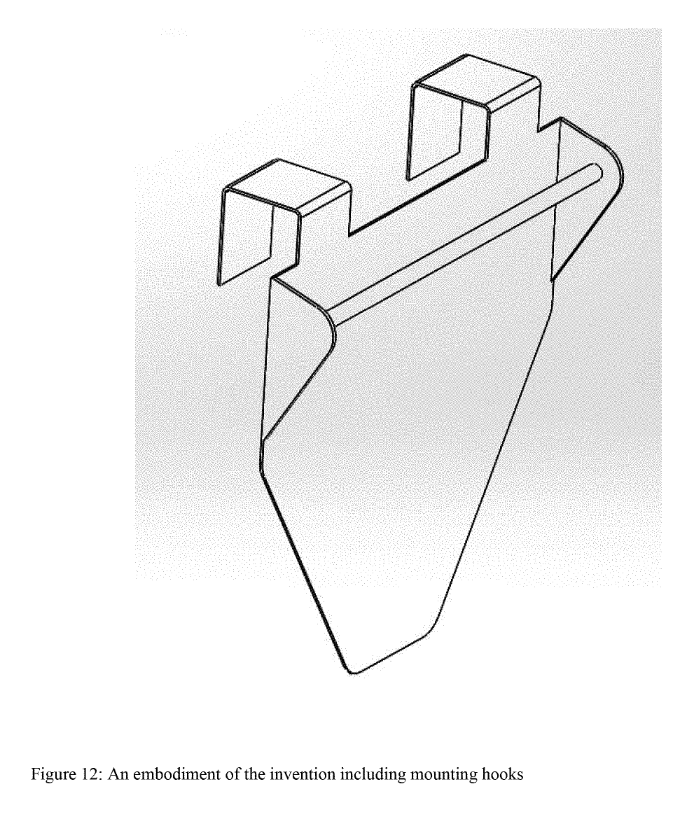

### DETAILED DESCRIPTION OF SPECIFIC EMBODIMENTS

Unless otherwise defined, all terns (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure will not be interpreted in an idealized or overly formal sense unless expressly so defined herein.

Bicycle pannier support devices, apparatuses, and methods for easily filling, emptying and storage of bicycle panniers are discussed herein. In the following description, for purposes of explanation, numerous specific details are set forth in order to provide a thorough understanding of the present invention.

The present disclosure is to be considered as an exemplification of the invention, and is not intended to limit the invention to the specific embodiments illustrated by the figures or description below. In describing the invention, the term “pannier” is used. It is to be clear that the scope of the invention includes interaction with single or multiple panniers.

### Advantages

Embodiments of this invention eliminate the issue of spilled drinks, damaged pannier contents and user frustration caused by panniers tipping over when placed on the ground, floor or other horizontal surface. By having the pannier hanging from a wall or other support surface, some embodiments of this invention eliminate the need for the user to bend over to the ground to access a panier, reducing frequency of a sore lower back. By supporting the bag for the user, some embodiments of this invention enable the user to utilize both hands to search through the contents of the pannier, reducing frustration in scenarios such as when searching to find keys that have vibrated their way to the bottom of the pannier during a ride. By supporting the pannier, some embodiments of this invention eliminate the impact shock experienced by pannier contents from placing the pannier on the floor or ground. Reducing damage to laptops, tablets and fruit are example advantages provided by these embodiments. Some embodiments drastically reduce wear to the pannier, thus extending the effective weather resistance and reflectivity of the pannier. The extension of weather resistance and reflective characteristics extends the overall life of the pannier, reducing replacement costs to the user. Some embodiments allow the user to utilize the pannier's existing clip mechanisms to attach and detach the pannier to and from the embodiment. This utilization of the current clip mechanisms creates the new and unexpected results that these embodiments of the invention are extremely fast and easy to use. Some embodiments also provide means of protecting the supporting surface from wear caused by frequent pannier attaching and detaching.

1. A bicycle pannier support device comprising:
a. a rod of predetermined length to accept connection to a bicycle pannier by said bicycle pannier's clip mechanisms and of material with sufficient strength, when supported by both ends, to support the weight of said bicycle pannier and contents when said pannier is hanging from said rod by said clip mechanisms
b. a sheet of rigid material of sufficient size to enable separation between a bicycle pannier and a vertical support structure such as a wall, door or office divider
c. means to connect said sheet of rigid material to said vertical support structure
d. means of connecting said rod to said sheet of rigid material whereby a bicycle pannier user is able attach said bicycle pannier support device to a vertical support structure and thereafter be able to support said bicycle pannier by the pannier's existing clip mechanisms conveniently off the ground.

2. The bicycle pannier support device in claim 1 wherein the means of connecting said sheet of rigid material to said vertical structure is with screws or nails.

3. A device providing means of securing a bicycle pannier to a support structure other than a bicycle rack.

4. The device in claim number 3 wherein the means of securing the bicycle pannier to the device utilizes said bicycle panier's existing bicycle rack connection mechanism or mechanisms, whereby the user is provided with a familiar, easy, connection experience when connecting the bicycle pannier to the device

5. The device in claim number 2 wherein the support structure other than the bicycle rack is a vertical support surface such as a wall, enabling the use of common fasteners such as nails, screws, or tape to attach the device to said vertical support surface

6. The device in claim number 3 wherein the support structure other than the bicycle rack is a vertical structure such as an office cubicle divider or door, enabling the device to be hooked over the top of said vertical support structure

7. The device in claim number 3 including a thin piece of material such as sheet metal or plastic sufficiently large enough to provide a barrier between the support structure and the bicycle pannier, whereby providing protection from damage such as scuffs or water marks common to repeated connection detachment with a bicycle pannier
